(19) United States
(12) Patent Application Publication
(10) Pub. No.: US 2016/0193744 A1
(43) Pub. Date: Jul. 7, 2016

(54) Onion cutter device with specialist cutting blades for various vegetable and fruit finishes

(71) Applicant: Priyesh Harshad Patel, Wilmington, DE (US)

(72) Inventor: Priyesh Harshad Patel, Wilmington, DE (US)

(21) Appl. No.: 14/590,140

(22) Filed: Jan. 6, 2015

(51) Int. Cl. B26D 3/26; A23N 15/08; A47J 42/40; A47J 43/25; B26D 3/11; A47J 25/00; B26D 3/28

(52) U.S. Cl. CPC B26D 3/26; A47J 25/00; A23N 15/08; B26D 3/283; A47J 43/25; B26D 3/11; A47J 42/40

(57) ABSTRACT

Onion and similar vegetable dicer slicer device that requires no peeling before use and achieves this task within 5-10 seconds. Specially designed hand press cover and rounded blades that help dice/slice the onion juicy leaves but not the dry outer scaly leaf. The easy lever forces the blades to cut the onion through to a clever inverted collection container to store the chopped product before you add to your dish. The device reduces irritation of the eyes and hence reducing tearing, stops wastage of onions and improves safety by preventing cuts on fingers of users from sharp knives. Chopping onions is quick, safe and pain free without the need to peel them. A choice of stackable blades provided in a separate tube for slicing any vegetable to the size and shape you want. Slice, dice, peel, chop, cut, wave cut or grate to a variety of sizes or thickness. Comes with a spiral cutting blade tool and an apple coring blade which cuts fruits into eighths whilst removing inner core stem. Top handle cover where blades of choice are fitted is used top side for flat blade and round blade cutting, and the underside for the disc blades with the cover turned upside down to reveal a new base for grating, slicing and more.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of the Invention

The present disclosure relates to kitchen vegetable cutting tools, more particularly the present disclosure relates to a device designed to slice or dice onions without the need to peel back the scaly dry outer leaf. The device also enables a whole array of vegetable and fruit manipulation using its wide array of swappable blades with a multifunctional hand press cover that enables use both top side and underside.

2. Description of the Related Art

Onion dicing and slicing takes a long time in the kitchen, an individual has to peel back the scaly outer leaves and then chop up the onion into small diced squares or long slices depending on use. Individuals cutting onions are at risk of cuts from sharp knives whilst chopping onions and irritation of eye causing tearing during the cutting process. This device attempts to tackle this problem and remove the risk of cuts, stops tears by reducing the time taken to chop onions whilst removing the need to peel them back first. Devices like Patent CN 201317018, CN 203266687 and CN 203092593 are very different in their approach, and all require peeling of the onion prior to use. Also majority of devices use a flat blade where as our device uses curved semicircular blades, with a total of 105 blades per unit with 2 round blade shapes and are expensive to produce due to the process involved in creating these rounded sharpened metal blades. Our device in addition is designed in a way that stops the outer scaly dry leaf from being forced through the blades due to a 2 mm variable gap between the bottom base unit of device and the rounded blades fitted upside down on the top handle cover of device. This device is unique to all other inventions in its design and approach which enables it to achieve dicing and slicing of a medium to large size onion in under 10 seconds without the need to peel it first. A product that will be regularly used by consumers and catering businesses to speed up their onion cutting time, whilst improving health and safety aspects of the process and their impact on the user's eye health. The device comes with 14 total blades which apart from its main function as a no peeling required onion dicer/slicer, also functions as a spiral julienne strips cutter; apple corer; peeler; grater; mandoline slicer; herb chopper; square, strip, pie shape, rectangular and wavy slice cutter. This product is multi functional with its primary focus being onion dicing and slicing.

### BRIEF SUMMARY OF THE INVENTION

In one aspect of the present invention is a fast Onion Dicer+Slicer Cutter which requires no peeling, the device's invention requiring no peeling is as a result of a +/−2 mm gap that is left between the bottom of semi-circular groove of the bottom base unit and the top of any blade tools in the slicing blade tool for 6 mm wide longitudinal cutting or the dicing blade tool for 6 mm wide Large square cutting. This prevents the outer scaly leaf from being forced through the blades and only allows the juicy onion leaves to be forced through the blades and chopped once the Hand press top base cover is fully pressed down. The hand press is then lifted and the scaly leaf can easily be removed from the top of the blades and discarded.

In another aspect of the present invention, It has stackable blades for either slicing or dicing, the blades have been specially designed rounded/curved rather than straight to achieve the goals set above, the gap described above enables tackling of the no peeling element of this invention, their design and arrangement specifically enables its function, the hand press top cover is hinged to increased amount of pressure applied to cut vegetables. The top cover has been designed to be used both top side for pressing down to apply suitable pressure and underside for alternate styles of cutting like grating and slicing. The device is easily accessible in all parts enabling easy cleaning and clearing of the diced onions through the blades, It stops tearing of the eyes due to irritation and reduces overall time taken to chop onions whilst making it extremely safe and reducing cuts the users normally get on their fingers from knives.

### DESCRIPTION OF THE DRAWINGS

FIG. 1 is a 3D view diagram showing the device in its normal resting position at a slant from above.

FIG. 2 is a cross sectional diagram showing the entire construction of the invention main unit from top to bottom side view. Point A to A cross-sectional view.

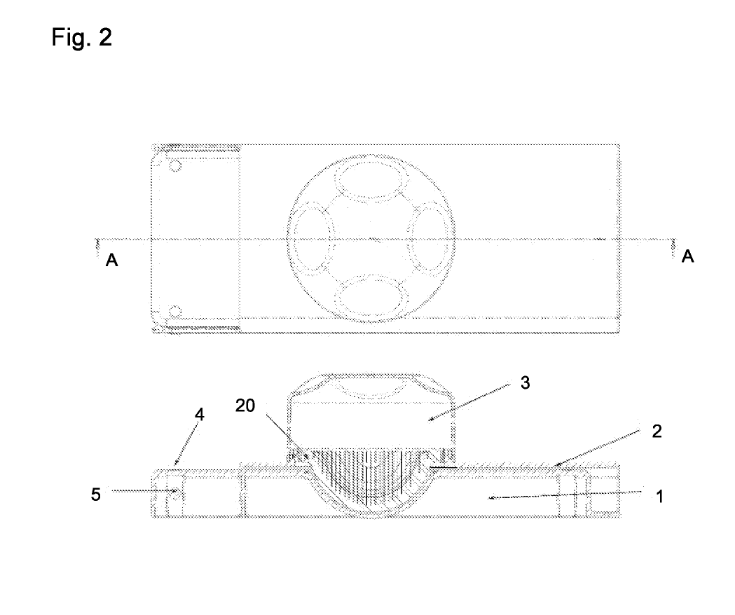

FIG. 3 is a blow out diagram showing the device stacked together from top to bottom.

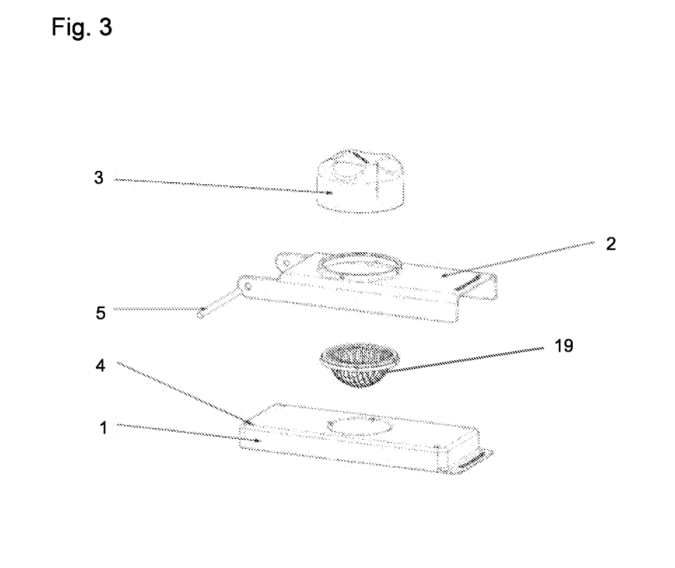

FIG. 4 is a cross sectional diagram, showing the arrangement of the blades stored in the container and with the top spiral cutting tool as its cover. Point A to A cross-sectional view.

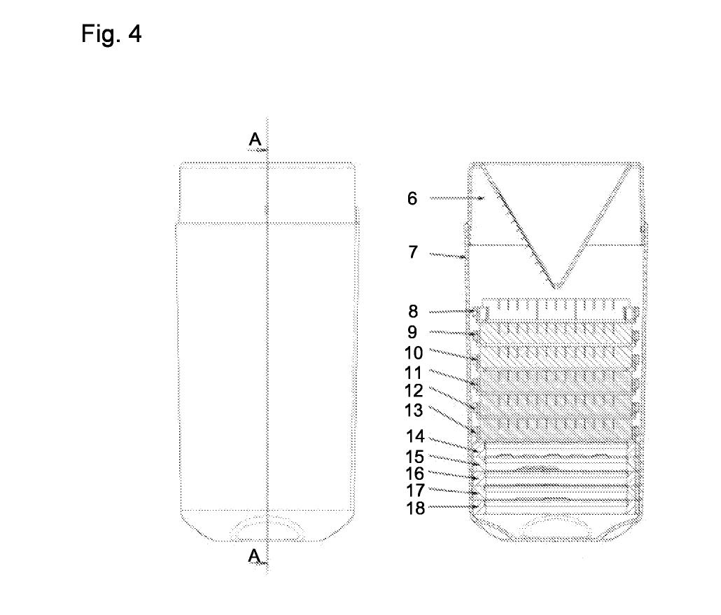

FIG. 5 is a perspective view of the various blades that are provided to be used in the device.

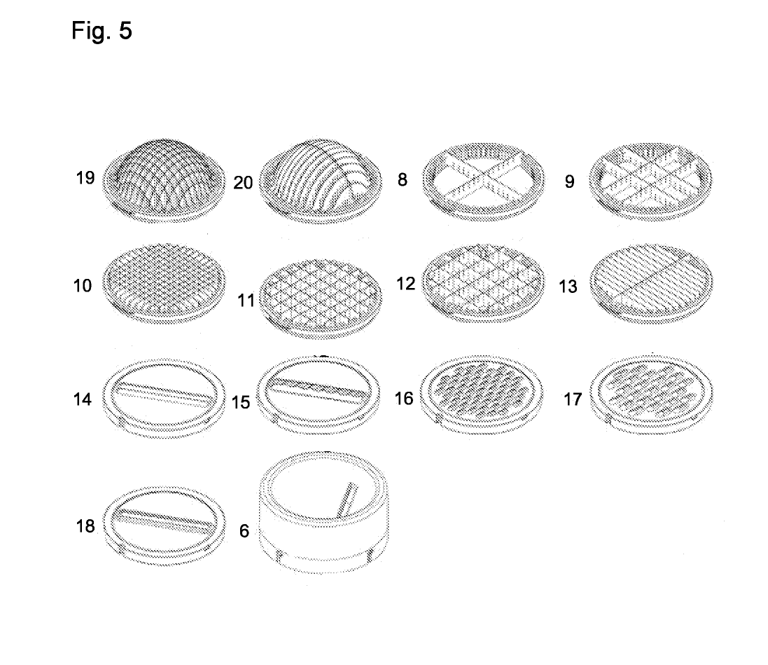

### REFERENCE NUMERALS IN THE DRAWINGS

1—Bottom base unit of device with semi-circular groove and plastic filler part for creating a flat platform if required when not cutting onions.
2—Hand press housing cover of device. Top unit Press part for applying physical pressure and forcing onions through blades slotted into part 2.
3—Onion collection and storage container, inverted. Also Houses 2 rounded onion blades. during storage. Larger container can be used to stack more blades.
4—Rubber grips for keeping device sturdy and avoiding slipping when on a surface.
5—Hinge that holds top and bottom of device together whilst acting as a pivot to enable increased force by pressing down on top of cover 2 to use blades.
6—Spiral Blade—spiral tool for julienne spiral strips cutting.
7—Large storage container which houses 12 flat, spiral and disc shape blades including a spiral cutting tool part 6 which is the cover.
8—Flat Blade—cuts into quarter pie shapes.
9—Flat Blade—cuts into eighths pie shape with core. Also used as apple corer and to slice fruits whilst discarding stem.
10—Flat Blade—cuts into 6 mm small squares. Also used as Herb chopper.
11—Flat Blade—cuts into 12 mm medium squares.
12—Flat Blade—cuts into 18 mm large squares.
13—Flat Blade—cuts into 6 mm rectangular thick slices.
14—Disc Blade—cuts into flat slices.
15—Disc Blade—cuts into wave pattern slices.
16—Disc Blade—grates into fine pieces.
17—Disc Blade—grates into coarse/larger pieces.
18—Disc Blade—used as a peeler for vegetables.
19—Rounded Blade—6 mm no peeling required onion dicing into squares.
20—Rounded Blade—6 mm no peeling required onion slicing into longitudinal.

### DETAILED DESCRIPTION OF THE INVENTION

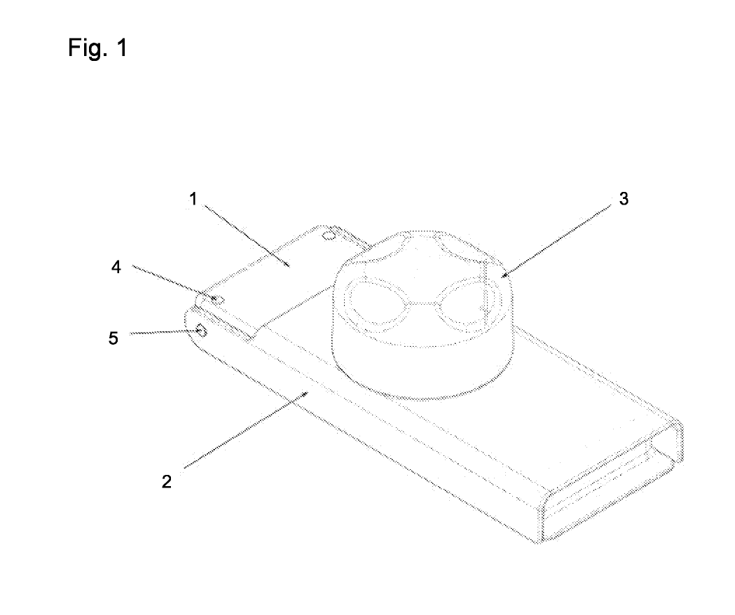

Referring to FIG. 1 3D slanted view with rounded blades housed in this compartment blades are stackable on each other for easy storage, there is a collection container inverted at the top for storing the diced or sliced onions as shown by the Onion Collection/Storage container 3.

The device is easy to clean, easy to store, BPA free, microwavable, dishwasher friendly, freezer safe, made of food grade plastic, the blades are all made of stainless steel or similar material, sharpened for quick and easy cutting. The device is opened by lifting the top cover upwards to create a V shape device on a hinge. The required blade is fixed into the top portion of part 2 from underneath, which houses the container 3 on the top. When using the rounded semi-circular blades, the onion is dropped into the round semi-circular slot of the bottom portion of 1, with the scaly leaf down towards the work surface. The top half part 2 containing the blade is closed on top of the bottom half containing the onion. When the hand lever is fully depressed, the onion is forced through the blades upwards, and the chopped product is pushed into the above storage container which is sitting on top of part 2 in an inverted position. When fully depressed, there is a 2 mm+/−1 mm gap left between the top of the blades and the base slot where the onion is placed. This leaves the scaly leaf of the onion untouched, so that it is not pushed through the blades to the storage area of the container and remains intact. The top half of the device can then be lifted, the onions removed from the storage area, and the scaly leaf of the onion can be removed from the top of the rounded blades 19 or 20 and easily discarded. The result is faster onion chopping without having to peel the onion first, and reduced wastage. All blades are compatible with the device and can be interchanged and used in the same manner with other vegetables. The device makes the chopping of the Onion very quick, in just 5-10 seconds you can have the diced and sliced onions from whole to chopped. The speed of cutting each onion ensures minimal irritation of the eyes and reduces tearing and sore eyes. The device gives you perfectly square diced onions or slices every time and its safety approach means no more finger cuts from knives whilst chopping onions. It contains a slicing blade which cuts onions into 6 mm thin slices as shown by the slicing blade tool for 6 mm wide longitudinal cutting 20. It contains a dicing blade, 6 mm squares as shown for 6 mm wide small square cutting 19. The device has a separate spiral cutting tool 6 which is also a cover that sits on the blade storage container 7, this tool creates julienne and spiral strips of vegetable cuttings. This container 7 stores all 12 other blades described, Flat blades 8, 9, 10, 11, 12, 13, Disc blades 14, 15, 16, 17, 18 and the Spiral cutting tool 6 as the cover of unit. There is room left in the container for the addition and storage of more flat or disc shaped commonly used blades which may be available in the future to the user. The rounded blades are stored in the main device unit inside the smaller container 3 and shapes are shown by 19 and 20.

The device as a whole is an all-in-one tool for various kitchen cuttings needs with its primary function as a specially design onion cutter that requires no peeling. The device as a whole can slice, dice, peel, chop, cut, wave cut or grate to a variety of sizes or thickness. End products of vegetable and fruit cuttings are the result of the user's creativity with the device.

1-4. (canceled)

5. A cutting assembly comprising:
a base unit having a recess with a curved bottom configured to receive an object to be cut;
a hand press hingedly connected to the base unit, the hand press having an aperture aligned with the recess when the hand press is in a closed position;
an inverted container removeably connected to a top surface of the hand press about the aperture; and
a plurality of curved blades removeably connected to a bottom surface of the hand press about the aperture,
wherein the plurality of curved blades have a profile corresponding to the curved bottom of the recess, and
wherein the plurality of curved blades are spaced from the curved bottom of the recess when the hand press is in a closed position.

6. The cutting assembly of claim 5, wherein the object to be cut is an onion, and wherein closing the hand press while an onion is disposed in the recess causes the plurality of curved blades to cut the onion into a plurality of onion pieces and forces the plurality of onion pieces upwards into the inverted container, while a scaly leaf of the onion remains in the recess.

7. The cutting assembly of claim 5, wherein the plurality of curved blades are a plurality of semi-circular blades.

8. The cutting assembly of claim 5, wherein the plurality of curved blades are spaced from the curved bottom of the recess by a gap between 1 mm and 3 mm.

9. The cutting assembly of claim 5, further comprising a plurality of replacement blades configured to be removeably connected to the bottom surface of the hand press about the aperture.

10. The cutting assembly of claim 9, wherein the plurality of replacement blades includes straight blades.

11. The cutting assembly of claim 9, wherein the plurality of replacement blades includes a grating tool.

12. The cutting assembly of claim 5, wherein the hand press is configured to rotate over 300 degrees with respect to the base unit.

13. A kit comprising:
a base unit having a recess with a curved bottom configured to receive an object to be cut;
a hand press configured to be rotatably connected to the base unit,
wherein the hand press is configured to rotate over 300 degrees with respect to the base unit,
wherein the hand press has an aperture aligned with the recess when the hand press is in a closed position;
an inverted container configured to be removeably connected to a top surface of the hand press about the aperture; and
a plurality of blade devices configured to be removeably connected to a bottom surface of the hand press about the aperture,

14. The kit of claim 13, wherein the plurality of blade devices includes at least one blade device having curved blades with a profile corresponding to the curved bottom of the recess.

15. The kit of claim 13, wherein the plurality of blade devices includes at least one spiral cutting tool.

16. The kit of claim 13, further comprising a blade storage container configured to house the plurality of blade devices.

17. The kit of claim 16, further comprising a cover for the blade storage container, wherein the cover includes a spiral cutting tool.

18. A method of cutting an object having a skin, the method including:
providing a cutting assembly having a base unit with a recess and a hand press hingedly connected to the base unit, wherein the recess has a curved bottom and wherein the hand press has an aperture aligned with the recess;
opening the hand press relative to the base unit;
connecting a cutting tool to the hand press at a location proximate to the aperture, wherein the cutting tool includes a plurality of curved blades having a profile corresponding to the curved bottom of the recess;
placing an object having a skin in the recess; and
closing the hand press such that the plurality of curved blades cut the object.

19. The method of claim 18, further comprising connecting an inverted container to a top surface of the hand press about the aperture.

20. The method of claim 18, wherein the closing the hand press causes the plurality of curved blades to push the skin to the curved bottom of the recess.

21. The method of claim 20, further comprising opening the hand press and disposing of the skin.

22. The method of claim 18, further comprising removing the cutting tool and replacing the cutting tool with a second cutting tool.

23. The method of claim 22, wherein the second cutting tool has straight blades.

24. The method of claim 22, wherein the cutting tool has curved blades spaced more closely than the curved blades of the second cutting tool.
